(19) United States
(12) Patent Application Publication
(10) Pub. No.: US 2025/0347772 A1
(43) Pub. Date: Nov. 13, 2025

(54) A CONTROLLER FOR CONTROLLING A RADIO FREQUENCY, RF, BASED SENSING SYSTEM AND A METHOD THEREOF

(71) Applicant: SIGNIFY HOLDING B.V., EINDHOVEN (NL)

(72) Inventors: GERARDUS WILHELMUS THEODORUS VAN DER HEIJDEN, HAAREN (NL); PIETER DIEDERIK DE VREEZE, 'S-HERTOGENBOSCH (NL)

(21) Appl. No.: 18/867,121

(22) PCT Filed: May 11, 2023
(86) PCT No.: PCT/EP2023/062588

§ 371 Date: Nov. 19, 2024

(30) Foreign Application Priority Data
May 19, 2022 (EP) 22174208.3

(51) Int. Cl. G01S 7/40; G01S 7/00; G01S 13/00; G01S 13/86

(52) U.S. Cl. CPC G01S 7/40; G01S 13/003; G01S 13/86; G01S 7/006

(57) ABSTRACT

A method of configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the method comprises clustering the plurality of nodes in two or more clusters based on the proximity of the plurality of nodes, determining a suitability of the plurality of nodes in each of the two or more clusters for transmitting and/or receiving the RF signals for RF sensing, selecting one or more nodes from each of the two or more clusters to act as a transmitter and/or a receiver for RF sensing system based on the determined suitability, instructing the selected one or more nodes to act as a transmitter and/or a receiver for the RF sensing system.

### FIELD OF THE INVENTION

The invention relates to a method of configuring a radio frequency, RF, based sensing system. The invention further relates to a controller, a system, and a computer program product for configuring a radio frequency, RF, based sensing system.

### BACKGROUND

Radio frequency-based sensing is a sensing mechanism involving wireless transceivers (or transmitters/receivers) arranged for transmitting and receiving radiofrequency (RF) signals. These RF signals, which may also be used for radio communication, when passing through a sensing volume, are affected by presence/movement of a person within the sensing volume e.g., via reflection, absorption, scattering etc. The radiofrequency-based sensing uses such deviations of radiofrequency signals to infer presence/motion of the person. Radiofrequency-based sensing also extends to other applications such as location detection, fall detection, gesture detection, vital signs detection etc. which are also based on how radiofrequency signals are affected in the sensing volume.

US 2021/185485 A1 discloses a system for selecting one or more devices in a wireless network for transmitting, receiving and/or processing a radio frequency signal for presence and/or location detection comprises at least one processor configured to determine a suitability of each of a plurality of devices for transmitting, receiving and/or processing a radio frequency signal for presence and/or location detection, select a subset of devices from the plurality of devices based on the suitability determined for each of the plurality of devices, and instruct at least one of the subset of devices to act as a device for transmitting, receiving and/or processing a radio frequency signal for presence and/or location detection.

### SUMMARY OF THE INVENTION

The inventors have realized that choosing all nodes to be a part of RF sensing in an environment will flood the network by RF signals which are transmitted and received by the nodes. The inventors have further realized that the selection of all the nodes will also consume more power and utilize more internal resources since all nodes need to communicate, gather data and process all information.

It is therefore an object of the present invention to optimize the selection of the nodes in a sensing area within an environment.

According to a first aspect, the object is achieved by a method of configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the method comprises clustering the plurality of nodes in two or more clusters based on the proximity of the plurality of nodes, determining a suitability of the plurality of nodes in each of the two or more clusters for transmitting and/or receiving the RF signals for RF sensing, selecting a first subset of nodes from a first cluster of the two or more clusters, and selecting a second subset of nodes from a second cluster of the two or more clusters to act as a transmitter and/or a receiver for RF sensing system based on the determined suitability, instructing nodes from the selected first subset and the second subset to act as a transmitter and/or a receiver for the RF sensing system.

The method relates to RF sensing system. The system may be arranged for sensing an activity state or a characteristic of an object. The activity state or characteristic may comprise, presence, motion, vital signs, gesture, fall, location etc. The object may comprise living objects such as humans, animals etc. and/or non-living objects such as cars, atmospheric conditions etc. The sensing may be based on how the radio frequency signals are affected by the object in an environment compared to a baseline (initial values defined for the environment).

The plurality of nodes is (physically) located in an environment. The environment may be an indoor environment such as office, home, arena etc., or an outdoor environment such as streets, parking lot etc. The method comprises clustering the plurality of nodes in two or more clusters based on the proximity of the plurality of nodes. In an example, the proximity may only be an indication based, e.g., on RSSI signal strength, variation of the RSSI signal data etc. The proximity may also be represented by room names and which nodes are in the room, but also on similar names etc. The environment may comprise any number of nodes. For example, in a larger space, there may be a plurality of nodes such as 50, 100 or even higher number of nodes. These nodes may be clustered in subgroups based on the distance between these nodes. For instance, a subset of nodes which are close to each other may be clustered or grouped in one cluster. In an example, the cluster size for different clusters may vary based on the arrangement of nodes in the environment.

The method further comprises determining a suitability of the plurality of nodes in each of the two or more clusters for transmitting and/or receiving the RF signals for RF sensing. The suitability is based on the overall performance of RF sensing system and/or network communication. In an example, the suitability is determined for each of the plurality of nodes in each of the two or more clusters. Alternatively, suitability is determined for a subset of nodes in each of the two or more clusters.

Since the method further comprises selecting a first subset of nodes from a first cluster of the two or more clusters, and selecting a second subset of nodes from a second cluster to act as a transmitter and/or a receiver for RF sensing system based on the determined suitability, and further comprises instructing the selected one or more nodes to act as a transmitter and/or a receiver for the RF sensing system, the selection of the nodes in a sensing area is optimized within an environment in view of overall performance of the RF sensing system and/or (network) communication. By not selecting nodes that are not suitable or are less suitable, the network traffic is minimized which improves overall RF sensing performance. Furthermore, the not-selected-nodes have more time for network communication and resources for network communication are thus not wasted.

The first cluster may comprise the selected first subset and the not-selected other subset of the nodes. Therefore, the total number of nodes in the first cluster is the sum of the selected first subset and the not-selected other subset of the nodes. Similarly, the second cluster may comprise the selected second subset and the not-selected other subset of the nodes. Therefore, the total number of nodes in the second cluster is the sum of the selected second subset and the not-selected other subset of the nodes. The subset may comprise one node or more than one node. In an example, the number of nodes in the subset is less than the total number of nodes.

In an embodiment, the determination of at least part of the suitability of a node of the plurality of nodes may be based on assessing at least one of: hardware capabilities of the node, one or more RF characteristics of the node, mounting orientation of the node, wireless interference close to the node.

The selection criteria may comprise hardware capabilities, e.g., that the nodes with required RF sensing capabilities are selected. The one or more RF characteristics may for example comprise radiation patterns, directionality of the antenna, transmit power, and/or reception sensitivity. Wireless interference may hamper the performance by reducing the reception of RF signals, therefore, the selection may be based on the wireless interference close to the node. The selection may be dynamic since the wireless interference may vary over time. With these selection criteria, the performance of RF sensing system is further improved.

In an embodiment, the determination of at least part of the suitability of a node of the plurality of nodes may be based on historical data relating to the node and/or by assessing the node's spatial location and/or condition of the environment.

As an example of the latter, if the node is a garden light located in an outdoor environment, and is arranged for performing RF sensing, a lighting device in the sun might have different sensitivity than a lighting device in the shade, e.g. due to expansion of substrates which lead to variations in a track antenna's length and thermal shift of component values like RF matching circuits and crystals, which lead to a deviated carrier frequency with respect to the center frequency of the selected band, for example. The environmental condition may be a weather condition, for example.

In an embodiment, the determination of at least part of the suitability of a node of the plurality of nodes may be based on the type of detection performed by the RF sensing system.

The RF sensing may be arranged for performing one or more of presence detection, motion detection, vital signs detection such as breathing rate, heart rate etc., fall detection, sleep monitoring, location detection, people counting, people tracking, gesture detection etc. In this advantageous embodiment, the nodes are selected based on the type of detection, e.g., the nodes which are more suited to the type of detection.

In an embodiment, the steps of clustering, determining, and selecting may be performed as part of commissioning the plurality of nodes and/or after commissioning the plurality of nodes.

The nodes may be selected after use of the plurality of nodes or after receiving information from a similar building space elsewhere (e.g., from another floor or another building). In the commissioning process, some nodes may be marked as being more or less suitable for the sending function than others. A suitability of a node may be determined, for instance, based on how critical the node is for routing messages. The latter is an indication of how much additional resources/bandwidth the node would have left for additional RF-based sensing. A suitability of a device may alternatively or additionally be determined, for instance, based on how much non-routing or non-rebroadcasting traffic a node needs to send (sensor) or receive (actuator, e.g., light), as the associated latency requirement may influence the decision on suitability.

In an embodiment, the plurality of nodes may comprise at least one lighting device. For this example, the determination of at least part of the suitability of a lighting device of the plurality of nodes may be based on assessing expected and/or past use of a lighting and/or network function of the node and/or any other expected and/or past use of the node.

The plurality of nodes may comprise at least one lighting device. Lighting devices are more and more equipped with wireless transceivers to enable smart functionality and are often located in quantities and at locations well suited for RF sensing applications, for instance, presence detection, motion detection etc. For example, a lighting device that is always on may be preferable to a light of which the on/off state changes often. In this example, the off condition may comprise that the lighting device may be powered but not providing illumination (e.g., in a sleep mode). The expected use of a lighting function may be derived from a floorplan or from other devices in similar situations (e.g., from devices on a floor in the same building on which wireless lighting has already been installed).

When assessing the use of a network function, how this use is performed may also be assessed. For example, a node that is used a lot to route messages between two other nodes and succeeds 100% of the times in relaying the message does not perform the same as a node that does the same routing but succeeds only 70%. The latter could be an indication of some external factor affecting the node's operation (regardless of the level of usage). The performance of a network function such as routing messages and being a proxy node for streaming could possibly also result in visible impact (though not necessarily on the device itself, but rather on nodes served by it) and this use of the device may be assessed as well.

In an embodiment, the determination of at least part of the suitability of a lighting device of the plurality of nodes may be based whether the lighting device is operated by a battery-operated wall switch or a legacy wall switch, an occupancy sensor, a motion sensor, a sensor bundle, a window blind controller and/or a mains-powered wireless switch.

A light controlled by a legacy wall switch may be considered to be less suitable, because the light switch cuts the power to the light, thereby making it incapable to perform RF-based sensing. If a light is equipped with a sensor bundle but the sensor bundle output is not used for the purpose of real-time adjustments of the light output of other lighting devices (e.g., certain wireless lights map the temperature and humidity across the room without any dynamic lighting control e.g. an emergency lighting fixture) and/or not used for real time adjustment of this lighting device hosting the sensor bundle, the latency will typically not be critical. The sensor bundle may comprise a CO2 sensor, a humidity sensor, a microphone (for sound analytics), a volatile organic component sensor and/or a temperature sensor, for example. Sensors that use Ultra Wide Band (UWB) and LiFi sensor technologies may also be used.

In an embodiment, the method may further comprise assigning a transmitter role to a first node in a first cluster of the two or more clusters and a receiver role to a second node in a second cluster of the two or more clusters. The assignment of transmitter and/or receiver role may be based on the criteria for the selection of the first and/or second subset of nodes. In other words, the criteria such as hardware capabilities, mounting orientation etc. as used for the selection of the first and the second subset may also be used for the assignment (selection) of the transmitter and/or receiver role.

In an embodiment, the method may further comprise determining a communication quality between the transmitter-receiver pair; and wherein the determination of at least part of the suitability of a node of the plurality of nodes is based on the determined communication quality between the pair.

In an example, the first cluster comprises a transmitter and the second cluster comprises a receiver. The communication quality between the transmitter-receiver pair may be determined and compared with a certain threshold. If this determination is negative, e.g., the quality is below the threshold, this pair is determined not to be suitable. The communication quality typically depends on whether there are obstacles blocking the RF-based sensing path. RF-based sensing methods do not necessarily require direct line of sight between the nodes. However, wireless signals cannot see through certain obstacles. For instance, if the end-user re-arranges a large of piece of metal furniture (e.g., bookshelf), the RF-sensing path between the nodes may be compromised.

In an embodiment, the method may further comprise determining at a later moment, a further suitability of (each of) the plurality of nodes for transmitting, receiving the radio frequency signal, selecting a first subset of nodes from a first cluster of the two or more clusters and selecting a second subset of nodes from a second cluster of the two or more clusters to act as a transmitter and/or a receiver for RF sensing system based on the further determined suitability, instructing nodes from the selected first subset and the second subset to act as a transmitter and/or receiver for RF sensing system.

The selection process, in this example, may be a dynamic process, wherein the selection criteria may evolve over time, evaluate, or determined dynamically. For example, the wireless interference may change over time, i.e., one node suffering from the interference may become a suitable node later in time.

In an embodiment, the plurality of nodes may be further arranged for transmitting and/or receiving radio frequency, RF, signals for network communication, wherein the nodes which are not selected in the two or more clusters may be arranged for the network communication.

The RF signals may be advantageously also used for network communication, e.g., to carry network messages intended for communication between nodes. In order to optimize RF sensing system performance in view of the network communication, the nodes which are not selected in the clusters may be arranged to perform network communication. This results in a better utilization of the available network resources.

In an embodiment, the proximity of the plurality of nodes may be determined based on a characteristic of the received RF signal.

In this advantageous embodiment, the distance between the plurality of nodes may be determined based on the characteristic of the received RF signal. In an example, the characteristic may be Received Signal Strength Indication (RSSI). Additionally, and/or alternatively, (digital) floor map may be used to determine the location and distance between the nodes.

In an embodiment, the clustering may be performed by utilizing machine learning algorithms, preferably k-mean clustering. In an embodiment, the method may further comprise determining a maximum number of clusters based on one or more of: number of the plurality of nodes, type and/or size of the environment, user input.

The number of clusters may be upper bounded by some selection criteria. For example, it may be based on the number of nodes available, their distance w.r.t each other. A user may also be able to provide an input indicative of the maximum number of clusters.

According to a second aspect, the object is achieved by a controller for configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the control device comprises a processor arranged for executing the steps of the method of the first aspect.

According to a third aspect, the object is achieved by a system for configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the system comprises the plurality of nodes, and the controller according to the second aspect.

According to a fourth aspect, the object is achieved by a computer program product comprising instructions which, when the program is executed by a computer, cause the computer to carry out the steps of the method of the first aspect. According to a fourth aspect, the object is achieved by a computer program product comprising instructions which, when the program is executed by a processor of the controller according to the second aspect, cause the processor to carry out the steps of the method of the first aspect.

It should be understood that the computer program product, the controller, and the system may have similar and/or identical embodiments and advantages as the above-mentioned methods.

### BRIEF DESCRIPTION OF THE DRAWINGS

The above, as well as additional objects, features and advantages of the disclosed systems, devices and methods will be better understood through the following illustrative and non-limiting detailed description of embodiments of systems, devices and methods, with reference to the appended drawings, in which:

FIG. 1 shows schematically and exemplary an embodiment of a system for configuring a radio frequency, RF, based sensing system,

FIG. 2 shows schematically and exemplary an embodiment of a controller for configuring a radio frequency, RF, based sensing system,

FIG. 3 shows schematically and exemplary a flowchart illustrating an embodiment of a method for configuring a radio frequency, RF, based sensing system.

All the figures are schematic, not necessarily to scale, and generally only show parts which are necessary in order to elucidate the invention, wherein other parts may be omitted or merely suggested.

### DETAILED DESCRIPTION OF EMBODIMENTS

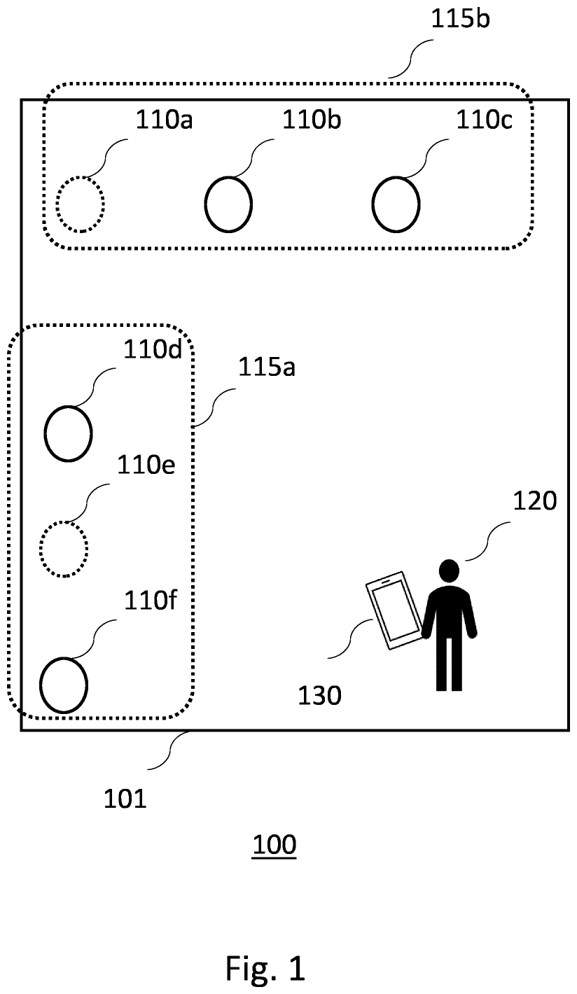

FIG. 1 shows schematically and exemplary an embodiment of a system 100 for configuring a radio frequency, RF, based sensing system 100. The system 100 comprises a plurality of nodes 110a-f. In this exemplary figure, the nodes are shown as lighting device. Additionally, and/or alternatively, the nodes may be one or more a sensor, a switch, a smart plug etc.

A lighting device 110a-f is a device or structure arranged to emit light suitable for illuminating an environment 101, providing or substantially contributing to the illumination on a scale adequate for that purpose. A lighting device 110a-f comprises at least one light source or lamp (not shown), such as an LED-based lamp, gas-discharge lamp or filament bulb, etc., plus any associated support, casing or other such housing. Each of the lighting device 110a-f may take any of a variety of forms, e.g., a ceiling mounted luminaire, a wall-mounted luminaire, a wall washer, or a free-standing luminaire (and the luminaires need not necessarily all be of the same type).

The plurality of nodes 110a-f comprises a transmitter and/or a receiver arranged for transmitting and/or receiving radio frequency, RF, signals for sensing an object in an environment 101. The transmitter and/or receiver may be comprised in a transceiver. For example, the node 110a-f may comprise a radar sensor wherein the transmitter and the receiver are comprised in the same node. The radar sensor may be a Wifi radar, an mm-wave (60 GHz ), and/or a UWB radar etc. The plurality of nodes 110a-f comprises appropriate circuitry (not shown) to transmit and receive RF signals using any communication protocol such as Zigbee, Bluetooth, Wifi, Thread etc. The RF signals may comprise any radiofrequency bandwidth such as 2.4 GHz, 5 GHZ, 24 GHz, 60 GHz etc.

The plurality of nodes 110a-f may be clustered in at least two clusters/groups 115a-b. The formation of clusters 115-ab may be based on the proximity of the plurality of nodes 110a-b. The proximity of the plurality of nodes 110a-f may be determined based on a characteristic of the received RF signal, e.g., RSSI, channel state information (CSI) etc. For example, RSSI may be evaluated to determine the distance of nodes w.r.t each other. Additionally, and/or alternatively, the proximity information may be obtained from floor map, user input etc. Any other source of proximity information may be used.

In this exemplary example, two clusters 115a-b are shown. There may be n numbers of clusters, wherein the n may be 5, 10, 100 etc. The clusters 115a-b may comprise the same type of nodes 110a-f or different types of nodes 110a-f. The number of nodes 110a-f or the maximum number of nodes 110a-f in a cluster may be based on number of the available plurality of nodes in the environment, type and/or size of the environment, user input etc. The user 120 may provide the input via a user device 130 such as a mobile phone, laptop, tablet etc.

A suitability of (each of) the plurality of nodes 110a-f in each of the two or more clusters 115a-b for transmitting and/or receiving the RF signals for RF sensing may be determined. In this example, the node 110a from the cluster 115a and node 110e from the cluster 115b are determined suitable for transmitting and/or receiving the RF signals for RF sensing. These two nodes 110a,e are then selected and instructed to act as a transmitter and/or a receiver role for the RF sensing system. In this example, based on hardware capabilities, wireless interference, mounting orientation etc., the role of transmitter may be assigned to node 110a, and the role of receiver may be assigned to 110e, or it can be vice versa.

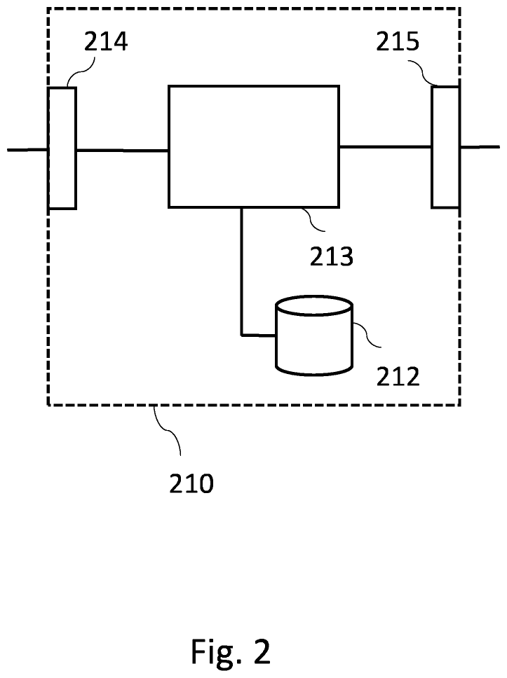

FIG. 2 shows schematically and exemplary an embodiment of a controller 210 for configuring a radio frequency, RF, based sensing system 100. The controller 210 may comprise an input unit 214 and an output unit 215. The input 214 and the output 215 units may be comprised in a transceiver (not shown) or input 214 may be comprised in a receiver and the output 215 is comprised in a transmitter, arranged for receiving (input unit 214) and transmitting (output unit 215) RF signals.

The controller 210 may further comprise a memory 212 which may be arranged for storing communication IDs of the lighting devices 110a-f and/or of the user device 130 etc. The controller 210 may comprise a processor 213 arranged for executing the steps or at least controlling the execution of the steps of the method according to the first aspect.

The controller 210 may be implemented in a unit separate from the lighting devices 110a-f/user device 130, such as wall panel, desktop computer terminal, or even a portable terminal such as a laptop, tablet or smartphone. Alternatively, the controller 210 may be incorporated into the same unit as the user device 130 and/or the same unit as one of the lighting devices 110a-f. Further, the controller 210 may be implemented in the environment 101 or remote from the environment 101 (e.g. on a server); and the controller 210 may be implemented in a single unit or in the form of distributed functionality distributed amongst multiple separate units (e.g. a distributed server comprising multiple server units at one or more geographical sites, or a distributed control function distributed amongst the lighting devices 110a-f or amongst the lighting devices 110a-f and user device 130). Furthermore, the controller 210 may be implemented in the form of software stored on a memory (comprising one or more memory devices) and arranged for execution on a processor (comprising one or more processing units), or the controller 210 may be implemented in the form of dedicated hardware circuitry, or configurable or reconfigurable circuitry such as a PGA or FPGA, or any combination of these.

To enable the controller 210, for example, to receive or transmit RF signals, the communication may be implemented in by any suitable wireless means such as a local (short range) RF network, e.g., a Wi-Fi, ZigBee, Bluetooth or Thread network; or any combination of these and/or other means.

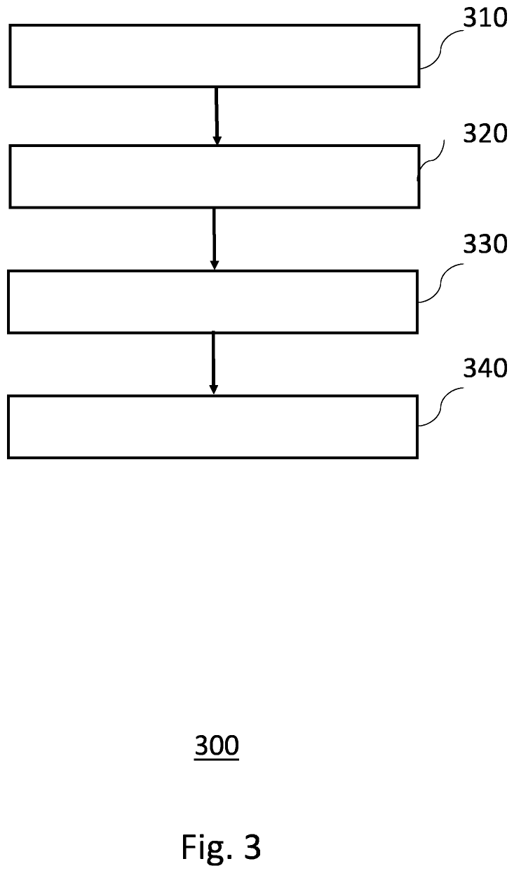

FIG. 3 shows schematically and exemplary a flowchart illustrating an embodiment of a method 300 for configuring a radio frequency, RF, based sensing system 100. The method 300 may comprise clustering 310 the plurality of nodes 110a-f in two or more clusters 115a-b based on the proximity of the plurality of nodes 110a-f. A threshold may be defined such that if the proximity of the nodes is within the threshold distance, they are collected in a cluster. The clustering 310 may be based on regions in the environment 101, e.g., in a living room, nodes around TV may be clustered in one group. The clustering may be performed by utilizing machine learning algorithms, preferably k-mean clustering. Other algorithms for clustering known in the art is not excluded. K-mean clustering is a method of vector quantization, that aims to partition n observations into k clusters in which each observation belongs to the cluster with the nearest mean (cluster centers or cluster centroid), serving as a prototype of the cluster. The clusters 115a-b may have different types of nodes 110a-f, different number of nodes 110a-f etc. The clustering 310 may vary over time.

The method 300 may further comprise determining 320 a suitability of the plurality of nodes in each of the two or more clusters 115a-b for transmitting and/or receiving the RF signals for RF sensing. The suitability may be determined such that the selection of the plurality of nodes 110a-f to perform RF sensing is optimized. The selection may be based in view of network communication such that the network traffic is minimized. Different selection criteria, as discussed before, may be considered to determine the selection of the plurality of nodes 110a-f.

The method 300 may further comprise selecting 330 a first subset of nodes 110a-f from a first cluster of the two or more clusters 115a-b, and selecting 330 a second subset of nodes 110a-f from a second cluster of the two or more clusters 115a-b to act as a transmitter and/or a receiver for RF sensing system 100 based on the determined suitability. In an example, the subset comprises only a single node, and whereas in other examples the subset comprises more than one node. In another example, not all the nodes are included in the subset, therefore, there is always a non-selected subset of nodes for each of the clusters. In other words, some of the nodes are excluded from the selected first and/or the second subset. Different clusters 115a-b may have different number of nodes 110a-f selected in the cluster 115a-b. In an example, the transmitter and the receiver are comprised in the same node, such that the transmitted RF signal is received back by the same node.

The method 300 may further comprise instructing 340 the selected one or more nodes 110a-f to act as a transmitter and/or a receiver for the RF sensing system 100. The controller 210 and/or the user device 130 may be arranged for instructing the selection of the one or more nodes 110a-f to act as a transmitter and/or a receiver for the RF sensing system 100.

The method 300 may be executed by computer program code of a computer program product when the computer program product is run on a processing unit of a computing device, such as the processor 213 of the controller 210.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise”, and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors or even the ‘cloud’.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. A method of configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the method comprises:
clustering the plurality of nodes in two or more clusters based on the proximity of the plurality of nodes,
determining a suitability of the plurality of nodes in each of the two or more clusters for transmitting and/or receiving the RF signals for RF sensing,
selecting a first subset of nodes from a first cluster of the two or more clusters and selecting a second subset of nodes from a second cluster of the two or more clusters to act as a transmitter and/or a receiver for RF sensing system based on the determined suitability,
instructing nodes from the selected first subset and the second subset to act as a transmitter and/or a receiver for the RF sensing system.

2. The method according to claim 1, wherein the determination of at least part of the suitability of a node of the plurality of nodes is based on assessing at least one of: hardware capabilities of the node, one or more RF characteristics, mounting orientation of the node, wireless interference close to the node.

3. The method according to claim 1, wherein the determination of at least part of the suitability of a node of the plurality of nodes is based on historical data relating to the node and/or by assessing the node's spatial location and/or condition of the environment.

4. The method according to claim 1, wherein the determination of at least part of the suitability of a node of the plurality of nodes is based on the type of detection performed by the RF sensing system.

5. The method according to claim 1, wherein the steps of clustering, determining, and selecting are performed as part of commissioning the plurality of nodes and/or after commissioning the plurality of nodes.

6. The method according to claim 1, wherein the plurality of nodes comprises at least one lighting device.

7. The method according to claim 1, wherein the method further comprises:
assigning a transmitter role to a first node in a first cluster of the two or more clusters and a receiver role to a second node in a second cluster of the two or more clusters.

8. The method according to claim 7, wherein the method further comprises
determining a communication quality between the transmitter-receiver pair; and wherein the determination of at least part of the suitability of a node of the plurality of nodes is based on the determined communication quality between the pair.

9. The method according to claim 1, wherein the method further comprises:
determining, at a later moment, a further suitability of the plurality of nodes for transmitting, receiving the radio frequency signal,
selecting a first subset of nodes from a first cluster of the two or more clusters and selecting a second subset of nodes from a second cluster of the two or more clusters to act as a transmitter and/or a receiver for RF sensing system based on the further determined suitability,
instructing nodes from the selected first subset and the second subset to act as a transmitter and/or receiver for RF sensing system.

10. The method according to claim 1, wherein the plurality of nodes is further arranged for transmitting and/or receiving radio frequency, RF, signals for network communication, wherein the nodes which are not selected in the two or more clusters are arranged for the network communication.

11. The method according to claim 1, wherein the proximity of the plurality of nodes is determined based on a characteristic of the received RF signal.

12. The method according to claim 1, wherein the method further comprises determining a maximum number of clusters based on one or more of: number of the plurality of nodes, type and/or size of the environment, user input.

13. A controller for configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the control device comprises a processor arranged for executing the steps of the method of claim 1.

14. A system for configuring a radio frequency, RF, based sensing system, wherein the RF sensing system comprises a plurality of nodes comprising a transmitter and/or a receiver arranged for transmitting and/or receiving radio frequency, RF, signals for sensing an object in an environment, wherein the system comprises:
the plurality of nodes,
the controller according to claim 13.

15. A computer program product comprising instructions which, when the program is executed by a processor of the controller, cause the processor to carry out the steps of the method of claim 1.
